(19) United States
(12) Patent Application Publication
(10) Pub. No.: US 2002/0150412 A1
(43) Pub. Date: Oct. 17, 2002

(54) Image heating apparatus for heating image on recording material

(75) Inventor: Toshinori Nakayama, Chiba (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/051,018

(22) Filed: Jan. 22, 2002

(30) Foreign Application Priority Data
Jan. 19, 2001 (JP) 012272/2001

(51) Int. Cl. G03G 15/20

(52) U.S. Cl. 399/330; 219/216; 432/60

(57) ABSTRACT

An object of the present invention is to provide an image heating apparatus for heating an image formed on a recording material that has a heat generating member, and an excitation coil for generating a magnetic field to induce an eddy current in the heat generating member, wherein a heat resistance value of the heat generating member per 1 cm² is 0.025° C./W or greater and 5° C./w or less.

### BACKGROUND OF THE INVENTION

1. Field of the Invention

This invention relates to an image heating apparatus like a heating and fixing apparatus carried on an image forming apparatus such as a copier or a printer.

2. Description of Related Art

As a fixing apparatus in an image forming apparatus, use has heretofore often been made of a heat roller system for heating a recording material while nipping and conveying the recording material by a fixing roller maintained at a predetermined temperature as a rotatable heating member, and a pressure roller which is a pressure member having an elastic layer and brought into pressure contact with the fixing roller.

In such a fixing apparatus, a halogen lamp disposed in the fixing roller generally used as the heat source of the fixing roller, and a heating method by the radiation heat of the halogen lamp is adopted. In this method there has been the leakage of light from the halogen lamp or energy efficiency which can be effectively used has been low and therefore, a relatively long time has been required until the temperature of the fixing roller reaches a predetermined temperature suited for fixing after the power source switch of the apparatus has been closed. Thus, there has been the problem that in the meantime, the user cannot use the image forming apparatus such as a copier and is compelled to wait for a long time.

As an apparatus satisfying such requirement, there has been proposed a fixing apparatus of an induction heating type in which a heat generating member is electromagnetically induced to generate heat. For example, in Japanese Patent Application Laid-Open No. 54-39645, an induction coil is spirally wound around a heat-resistant coil bobbin in a fixing roller mandrel of a metal conductor which is a hollow cylinder constituting a fixing roller. Design is made such that a high frequency current is supplied from a power source to the induction coil proximate to the inner surface of the fixing roller mandrel, and by a high frequency magnetic field produced thereby, an induction eddy current is generated in the fixing roller mandrel, and by the epidermal resistance of the fixing roller mandrel itself, the fixing roller mandrel itself is caused to generate Joule heat as a heat generating member. There has also been proposed a color image forming apparatus adopting this induction heating process therefore to thereby achieve energy saving.

FIGS. 7 and 8 of the accompanying drawings show an example of the fixing apparatus in such a color image forming apparatus. The fixing apparatus E which is an example of the prior art is a fixing apparatus of the induction heating type which is comprised of a fixing roller (heating roller) 10 comprised of a mandrel 11 which is a metal conductor formed in a hollow cylinder rotatably supported by means, not shown, and a pressure roller 2, and in which, as can be understood if reference is also had to FIG. 8, in the mandrel 11 of the fixing roller 10, an induction coil 14 is spirally wound on a heat-resistant coil bobbin 15 fixed to the apparatus against rotation. By an induction eddy current generated by a high frequency current being supplied from a power source 16 to the coil 14, the mandrel 11 generates Joule heat. In the fixing apparatus using such an induction heating process, the mandrel 11 generates heat and therefore, the warming-up time becomes short.

When a color image is to be formed, color toners such as cyan, magenta and yellow toners are used as developers and therefore, the apparatus is generally used with the amount of toners resting on an unfixed toner image on a recording material P being great as compared with a monochromatic image. Therefore, toners of three colors or so further rest on the unevenness of the surface of the recording material P and to fuse and fix an unfixed toner image formed by a great amount of toners resting thereon, a greater quantity of heat is required and thus, for the purpose of improving the tracing property and fixing property itself relative to the image, the fixing roller 10 need have moderate elasticity. Consequently, the fixing roller 10 in the color image forming apparatus using the induction heating process has an elastic layer 12 of silicon rubber such as HTV, LTV or RTV or rubber such as fluorine rubber or fluorine rubber latex formed on the fixing roller mandrel 11, and a surface layer 13 high in surface lubricating property is formed on the elastic layer 12.

A color image is great in the amount of toner resting thereon and therefore the recording paper P which is a recording material is liable to twine around the fixing roller 10 and heretofore, releasing agent oil such as silicone oil has been applied to the fixing roller 10. However, the oil has been directly applied to the fixing roller 10 and the oil has been indirectly supplied to the pressure roller 2 from the fixing roller 10 through a fixing nip N and therefore, the application of the oil to the pressure roller 2 becomes liable to cease, and this is disadvantageous for the prevention of the offset of the pressure roller 2 and thus, the copying with both side images for color DTP is very difficult. When a great amount of oil is applied to prevent it, there has been the inconvenience that oil stains occur to the recording paper P.

In order to solve such a problem, in Japanese Patent Application Laid-Open No. 10-148988, it is made possible to well fix color toners transferred to recording paper P without applying releasing agent oil to the fixing roller 10, etc.

That is, as a developer, use is made of a toner of a type including therein wax such as paraffin or olefin having a releasing property, and the fixing roller 10 is made into a roller construction in which an elastic layer 12 is provided on a mandrel 11 formed of a base material having rigidity, and fluorine resin good in the releasing property with respect to the toner including wax therein, for example, FEP or PFA+PTFE blend is provided as a surface layer 13 on the surface thereof, and moreover the thickness and hardness of the elastic layer 2b of the pressure roller 2 are selected and the pressure roller 2 is brought into pressure contact with the fixing roller 10 to thereby make good fixing possible while maintaining the separating performance even if silicone oil is not applied as in the prior art.

Besides, Japanese Patent Application Laid-Open No. 4-166966 discloses a fixing apparatus of the electromagnetic induction heating type using a film-like fixing roller reduced in heat capacity. This construction uses low heat capacity film to thereby keep a quick starting property and yet keep a separating property (curvature separation) by the curvature of the film.

However, even the above-described fixing apparatus E and an image forming apparatus provided with the fixing apparatus E have suffered from the following problems.

The elastic layer 12 on the fixing roller mandrel 11 makes the heat capacity of the fixing roller 10 great and the time until a predetermined fixing temperature is reached (waiting time) becomes long, and even if the induction heating process is used, the quick starting property is spoiled.

Also, due to the presence of the elastic layer 12, the heat resistance in the direction from the fixing roller mandrel 11 generating heat by the induction coil 14 which is a heat source toward the toner and the recording material P being in contact with the surface of the fixing roller 10, i.e., from the inner surface of the fixing roller toward the surface of the fixing roller, becomes great and the capability of supplying the quantity of heat taken away is the nip N from the heat surface (heat follow-up property) is spoiled.

So, if a small-diametered fixing roller 10 is used to make heat capacity small, when for example, color A3 recording paper having a great amount of toners resting thereon is to be fixed as the recording material P, the fixing roller 10 makes several full rotations on the recording paper P and therefore, if the heat follow-up property is bad, heat taken away in the first round cannot be supplied by the second round, and the temperature becomes lower toward the trailing end edge of the recording paper, and it is difficult for the wax included in the toner to ooze out, and the merit of using the wax-containing toner becomes null.

Also, as compared with the temperature of the surface of the fixing roller 10, the temperature of the inner surface thereof is liable to become high, and the greater is the heat resistance from the inner surface to the surface of the fixing roller 10 as when the fixing roller mandrel 11 and the elastic layer 12 are thick, the higher becomes the temperature of the inner surface. When the temperature of the inner surface of the fixing roller 10 becomes high, the atmospheric temperature of the interior of the fixing roller 10 also rises, but the magnetic field generating induction coil 14 in the fixing roller 10 also generates Joule heat and therefore, heat generating efficiency is reduced.

### SUMMARY OF THE INVENTION

The present invention has been made in view of the above-noted problems and an object thereof is to provide an image heating apparatus which can shorten waiting time and which is excellent in recording paper separating performance.

Another object of the present invention is to provide an image heating apparatus which can shorten waiting time and which is excellent in heat generating efficiency.

Still another object of the present invention is to provide an image heating apparatus comprising:

a heat generating member; and

an excitation coil for generating a magnetic field to induce an eddy current in the heat generating member;

wherein a heat resistance value of the heat generating member per 1 cm² is 0.025(° C./W) or greater and 5(° C./W) or less.

Further objects of the present invention will become apparent from the following detailed description when read with reference to the accompanying drawings.

### BRIEF DESCRIPTION OF THE DRAWINGS

FIG. 1 schematically shows the construction of the image forming apparatus of the present invention.

FIG. 2 is a cross-sectional view of the fixing apparatus A of the present invention.

FIG. 3 is a perspective view illustrating the arrangement mode of an induction coil in the fixing roller 1 of the present invention.

FIG. 4 is a schematic view illustrating the induction heating process in the fixing roller 1 of the present invention.

FIG. 5 is a cross-sectional view of the fixing apparatus C of the present invention and fixing apparatuses B and D which are the comparative examples of the present invention.

FIG. 6 shows the construction of a toner used in the image forming apparatus of the present invention.

FIG. 7 is a transverse cross-sectional view of a fixing apparatus E according to the prior art.

FIG. 8 is a longitudinal cross-sectional view of the fixing apparatus E according to the prior art.

### DESCRIPTION OF THE PREFERRED EMBODIMENTS

A fixing apparatus and an image forming apparatus according to the present invention will hereinafter be described in detail.

Embodiment 1

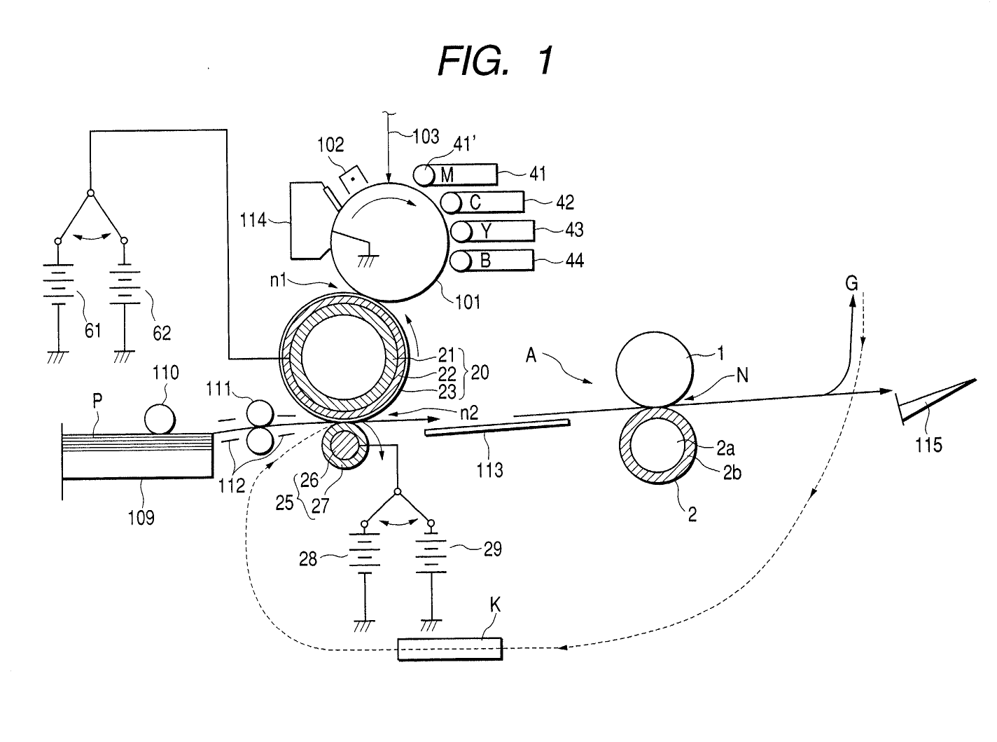

FIG. 1 shows the general construction of embodiment of the image forming apparatus of the present invention. While in this embodiment, a color image forming apparatus using an intermediate transferring member is used as the image forming apparatus, the form of the image forming apparatus is not restricted thereto.

In the present embodiment, the color image forming apparatus has as an image bearing member a photosensitive drum 101 rotatively driven at a predetermined peripheral speed in the direction of arrow, and image forming means such as a primary charger 102 is disposed around the photosensitive drum 101. The photosensitive drum 101 is uniformly charged to predetermined surface potential of a predetermined polarity by the primary charger 102, and by the exposure 103 of an image from the laser scanner (not shown) of exposing means, an electrostatic latent image of a first color, e.g. magenta component color, is formed on the surface of the photosensitive drum 101. This latent image is developed by a magenta developing device 41 and is visualized as a magenta toner image. The developing method is a monocomponent non-contact method using a non-magnetic toner as a developer, and a suitable developing bias voltage is applied to between the developing sleeve 41′ of the developing device 41 and the photosensitive drum 101, whereby the non-magnetic toner on the developing sleeve 41′ flies to the photosensitive drum 101 and adheres to the latent image to thereby develop it.

As an intermediate transferring member, an intermediate transferring roller 20 is disposed in contact with the photosensitive drum 101 with moderate pressure. The intermediate transferring roller 20 is comprised of a cylinder-shaped mandrel 21 and an elastic layer 22 of a non-foamed material or a foamed material having electrical resistance of medium resistance (volume resistivity being of the order of 10⁵ to 10¹¹Ωcm) provided thereon. In order to improve the releasing property of the surface of the elastic layer 22 relative to the toner, a releasing layer 23 of fluorine resin such as PTFE or silicone rubber which is good in the releasing property relative to the toner is formed on the surface of the elastic layer 22 by a tube or coat.

The toner image on the photosensitive drum 101 is transferred onto the surface of the intermediate transferring roller 20 by a suitable transfer bias voltage being applied to between the intermediate transferring roller 20 and the photosensitive drum 101 (a primary transferring nip n1) by a transfer bias voltage source 61 (primary transfer).

After the termination of the primary transfer, the photosensitive drum 101 has any primary-untransferred toner residual on its surface removed by a cleaning apparatus 114. Thereafter, a second color, i.e., cyan toner image (developed by a developing device 42), a third color, i.e., yellow toner image (developed by a developing device 43) and a fourth color, i.e., black toner image (developed by a developing device 44) are formed on the photosensitive drum 101 by way of similar processes, and are superimposed and primary-transferred onto the intermediate transferring roller 20, whereby superimposed images of toner images of four colors are formed on the intermediate transferring roller 20.

A secondary transferring roller 25 is installed on the side of the intermediate transferring roller 20 opposite to the photosensitive drum 101 for movement toward and away from the intermediate transferring roller 20. The secondary transferring roller 25 is formed by a mandrel 26 and an elastic layer 27 of medium resistance provided thereon.

A recording sheet P as a recording material from a sheet feeding cassette 109 is passed through the nip (secondary transferring nip n2) between the secondary transferring roller 25 and the intermediate transferring roller 20. The bias voltage source is changed over from a voltage source 29 to a voltage source 28 and a suitable transfer bias voltage is applied to between the intermediate transferring roller 20 and the secondary transferring roller 25, whereby the toner images of four colors on the intermediate transferring roller are collectively transferred onto the recording sheet P (secondary transfer). The recording sheet P is conveyed from the sheet feeding cassette 109 by a feed roller 110, and is supplied to the above-mentioned secondary transferring nip n2 by registration rollers 111 and a sheet feeding guide 112 before and behind them.

After the termination of the secondary transfer, any secondary-untransferred toners residual on the surface of the intermediate transferring roller 20 are returned onto the photosensitive drum 101 by a bias voltage of the polarity opposite to that during the primary transfer being applied to between the intermediate transferring roller 20 and the photosensitive drum 101 by a bias voltage source 62, and are finally collected by the cleaning apparatus 114.

The recording sheet P to which the toner images of four colors have been transferred as unfixed images is conveyed to a fixing apparatus A which will be described later in detailed via a guide 113, and passes through the fixing nip N between a fixing roller 1 which is a heating member and a pressure roller 2 which is a pressure member, whereby the color mixing of the toners and the fixing of the toners to the fiber of the recording sheet P are done. In the case of one-side image formation, the recording sheet P is intactly discharged to a sheet discharge tray 115. In the case of both-side image formation, the recording sheet P having left the fixing apparatus A is once conveyed in another sheet pass direction G, whereafter it is switched back and conveyed to a both-side unit K. During the image formation on a second side opposite to a first side of the recording sheet P, the recording sheet P arrives at the recording transfer nip n2, and the recording sheet P passes therethrough while the toner images are secondary-transferred to the opposite side of the recording sheet P, and the fixing of the toner images on the second surface is terminated via the fixing apparatus A, whereafter the recording sheet P is discharged to the sheet discharge tray 115.

Description will now be made of the fixing apparatus A which is the characterizing portion of the present invention.

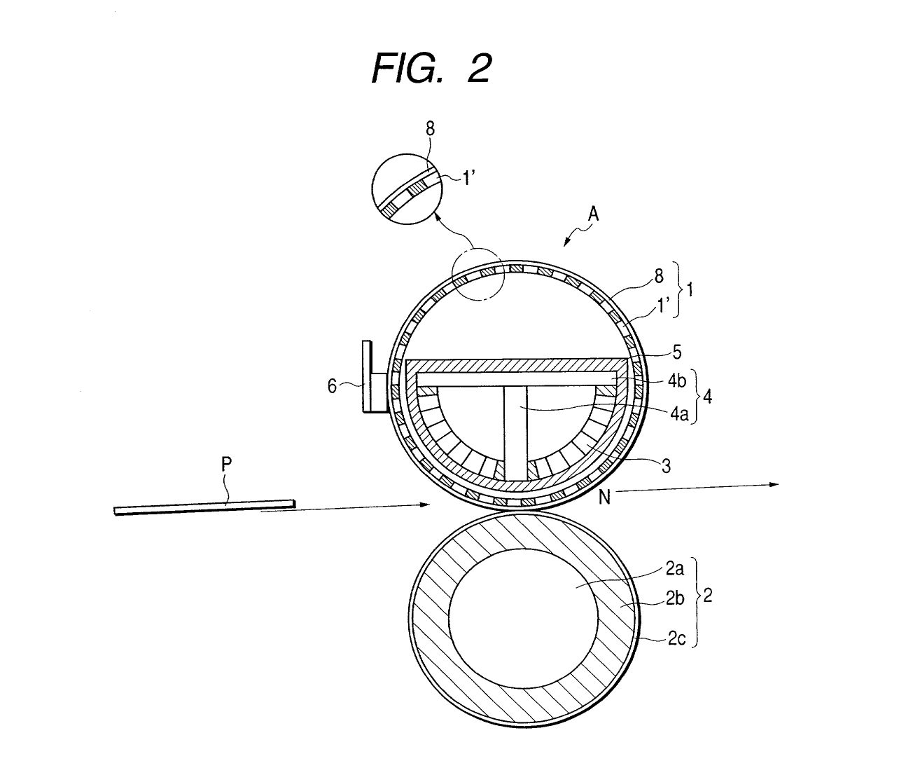

FIG. 2 shows the details of the fixing apparatus A in the present embodiment. The fixing apparatus A has the fixing roller 1 which is a rotatable heating member and the pressure roller 2 which is a pressure member vertically brought into pressure contact with each other. The two rollers 1 and 2, with the portion of pressure contact therebetween as the nip portion N, nip and convey therebetween the recording sheet P which is a recording material having an unfixed toner image formed on the surface thereof and at the same time, fix the unfixed toner image on the recording sheet P by heat given by the fixing roller 1 and pressure given by the pressure roller 2.

The fixing roller 1 is comprised by a cylindrical thin-walled metallic roller, i.e., a fixing roller mandrel 1′ which is a hollow metal conductor having an electrically conducting layer formed of an electrically conductive magnetic material such as iron, nickel or magnetic stainless steel (SUS430). In the present embodiment, a heat-resistant releasing layer 8 is formed on the outer peripheral surface of the fixing roller mandrel 1′ by coating it with fluorine resin such as FEP, PFA or PTFE, or fluorine rubber or fluorine rubber latex, or by the use of a tube.

An induction coil 3 which is the induction heating source of a heat source for generating a high frequency magnetic field is disposed in the hollow portion of the fixing roller mandrel 1′ to induce an induction current (eddy current) in the fixing roller mandrel 1′ and generate Joule heat. This state will now be described with reference to FIGS. 2, 3 and 4.

The induction coil 3 is disposed in the interior of a holder 5 formed of heat-resistant resin such as PPS, PEEK or phenol resin. The holder 5 is provided inside the fixing roller mandrel 1′, and is fixed against rotation by a fixing unit frame, not shown. In the present embodiment, in FIG. 2 which is a transverse cross-sectional view of the fixing apparatus A, the holder 5 is of a substantially semicircular shape along the fixing roller 1 and having its arcuate portion facing the nip N which is a fixing portion, and the induction coil 3 is provided on the entire area of the semicircular accurate inner wall thereof other than the portion of contact. Also, there is provided a core 4 formed into a T shape in cross-section by a vertical member 4a located in a diametral portion passing through the central point of the semicircle of the holder 5 and the point of contact of the nip portion, and a horizontal member 4b located in the chord portion of the semicircle of the holder 5, and for the core 4, use is made of a material great in permeability and small in self-loss.

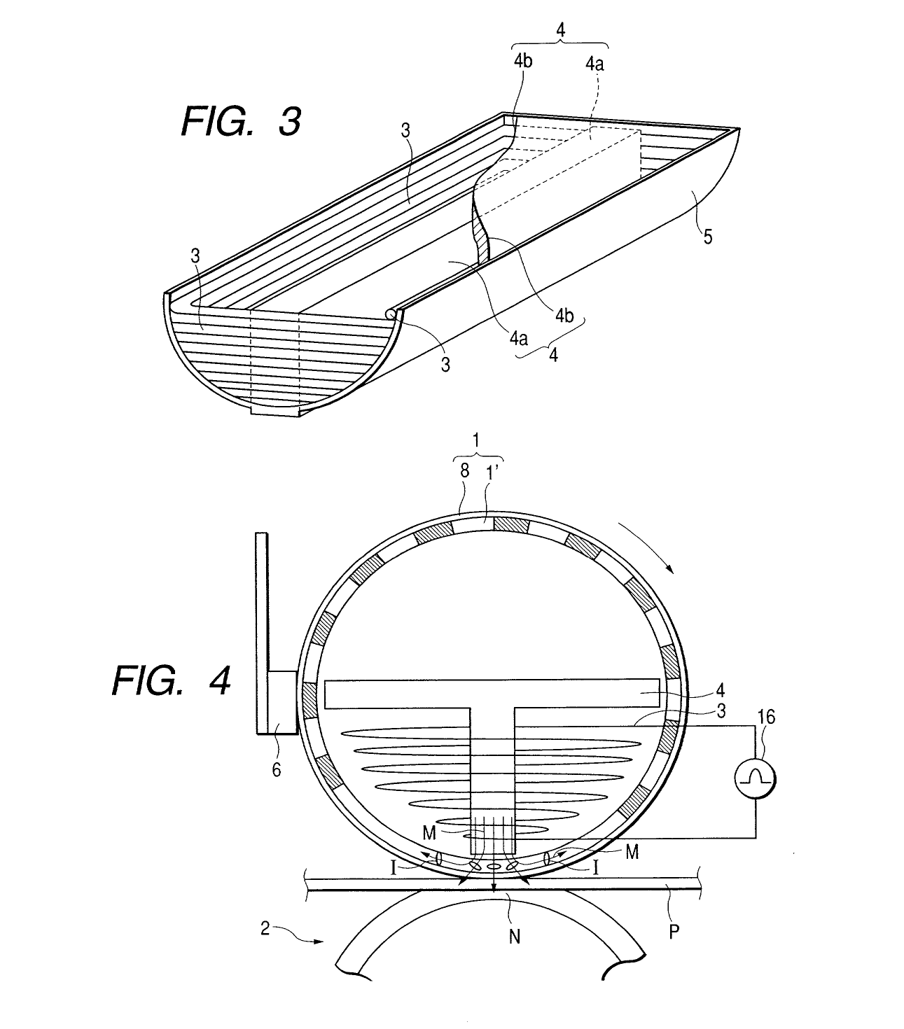

As shown in FIG. 3, the induction coil 3 makes one round of the lengthwise outer periphery of the distal end portion of the vertical member 4a of the core which abuts against the nip N so as to describe a rectangle, and is wound into a square coil shape from there toward the center of the fixing roller mandrel 1′ along the inner wall of the holder 5, and is formed so as to assume an arcuate shape linking the end portion of T of the core 4 together as viewed in the transverse cross-sectional view of FIG. 2, with the horizontal member 4b of the core 4 as the upper plane. Incidentally, the end of the induction coil 3 is connected with the AC power source (FIG. 4).

An alternating current which is an alternating current of 10 kHz to 100 kHz is applied from an alternating current power source 16 of a voltage Vpp=10 V to 2000 V and a frequency f=10 kHz to 5000 kHz which is an induction heating source to the induction coil 3. An alternating magnetic field induced by the alternating current causes an eddy current to flow to the inner surface of the fixing roller mandrel 1′ which is an electrically conducting layer to thereby generate Joule heat. This state is shown in FIG. 4. In the schematic view of FIG. 4, the holder 5 is omitted. A magnetic flux generated by the current applied to the coil 3 by the alternating current power source 16 is directed to the high permeability core 4 and causes the fixing roller mandrel 1′ to generate a magnetic flux M and an eddy current I in the fixing nip N. By this eddy current I and the specific resistance of the fixing roller mandrel 1′, the fixing roller mandrel 1′ generates Joule heat as a heat generating member. To increase this generated heat, the number of turns of the induction coil 3 can be increased, or a material high in permeability and low in residual magnetic flux density such as ferrite or Permalloy can be used for the core 4, or the frequency of the alternating current can be made high.

When it reaches a high temperature, the induction coil 3 rises in electrical resistance and becomes bad in power source efficiency. When electric power is further supplied to make up for it, further heat generation is caused and the coil falls into vicious circle. A coating of insulative heat-resistant resin such as PIW or AIW is provided on the surface of the coil 3, but when the amount of heat generation of the coil becomes too great, the heat-resisting temperature of the resin is exceeded and the insulativeness thereof is spoiled. The heat generation of the coil 3 also causes the temperature rise of the core 4. When it exceeds Curie temperature, the core 4 becomes extremely low in permeability and is aggravated in heat generating efficiency. So, a temperature sensor 6 is disposed so as to abut against the surface of the fixing roller 1, and automatic control is effected so that the supply of electric power to the induction coil 3 may be increased or decreased on the basis of the detection signal of the temperature sensor 6 whereby the surface temperature of the fixing roller 1 may become a predetermined constant temperature.

In the fixing roller 1 shown in FIG. 7, an elastic layer formed of LTV or HTV silicon rubber was formed on the mandrel 1′ in order to enable the nip N to be secured between it and the pressure roller 2. The elastic layer, however, makes the heat capacity of the fixing rubber 1 great and therefore, there arises the problem of the loss of the quick starting property of the image forming apparatus, and in order to solve it, the diameter of the fixing roller was made small to thereby suppress the heat capacity thereof. Therefore, in a color image forming apparatus like the present embodiment wherein the amount of toner resting on the unfixed toner image to be fixed is great, separability is lossed and problems such as the twining of the recording sheet P which is the recording material and the bad fixing of the lower end area of the recording sheet P arise. Also, the heat resistance from the fixing roller mandrel 1′ generating heat by the coil 3 which is the heat source to the recording sheet P, i.e., from the inner surface to the surface of the fixing roller 1, becomes great. Accordingly, the controlled temperature must be made high in order not to reduce the fixing property, and there has arisen a problem such as the deterioration of the internal member in the fixing apparatus due to the rise in the internal temperature. Consequently, in the present embodiment, an elastic layer of silicon rubber or the like is not provided, but fluorine resin such as FEP, PFA or PTFE, or fluorine rubber or fluorine rubber latex is formed on the outer peripheral surface of the fixing roller mandrel 1′ by coating or by the use of the tube.

Considering the heat resistance value of the fixing roller 1 in the radial direction thereof, i.e., the thickness direction thereof, the smaller is the heat resistance value, the more efficiently the heat can be applied to the recording sheet P and the toner. Therefore, if as the developer, use is made of a toner including therein wax such as paraffin or olefin which is a releasing agent, it is possible to melt the toner in a moment and cause the wax included therein to ooze out quickly, and good separating performance by the wax can be obtained.

Further, if the surface temperature of the fixing roller 1 is the same, the temperature of the inner surface of the fixing roller 1 becomes lower when the heat resistance value of the inner surface to the surface of the fixing roller 1 is smaller. When the temperature of the inner surface of the fixing roller 1 is low, the internal atmospheric temperature of the fixing roller 1 also becomes low and therefore, the temperature rise of the induction coil 3 can be mitigated.

When conversely, the heat resistance value of the inner surface to the surface of the fixing roller 1 becomes great, the separating performance becomes bad. This is because the toner cannot be melted quickly and the wax cannot be oozed out sufficiently.

Consequently, in the present invention, the heat resistance value can be obtained from the following expression, and the upper limit of the obtained heat resistance value was 5 (° C./W) per 1 cm² in the direction of heat transfer. The reason for this will be set forth later.

Heat resistance value=Σ((thickness of substance×area) / heat conductivity) (But the range of integration is from the inner surface to the surface of the fixing roller.)

In order to make the heat resistance value small, it would also occur to mind to make the thickness of the mandrel 1′ small. Actually, however, to obtain a sheet resistance value of 0.025(° C./W) per 1 cm² in the direction of heat transfer, it is necessary that the releasing layer 8 be 1 μm or less and the iron mandrel 1′ be several tens of μm, and a problem arises about the durability of the mandrel 1′ and the releasing layer 8 and this is not realistic. Consequently, means for defining the lower limit of the heat resistance value as 0.025(° C./W) per 1 cm² in the direction of heat transfer and making the heat resistance value low is not to make the mandrel 1′ thin, but to make the thickness of other layer of a non-metallic heat conductions proof material small. In the fixing apparatus A in the present embodiment, an elastic layer is not provided on the metallic roller, but the releasing layer 8 is directly provided on the mandrel 1′.

In this case, the releasing layer 8 is generally a coat or tube of FEP, PFA, PTFE or the like or fluorine resin composed of a mixture thereof, or fluorine rubber or fluorine rubber latex or the like and the heat conductivity thereof is 0.2 W (m•° C.) to 0.5 W/(m•° C.) and therefore, in order that the total heat resistance value of the mandrel and the releasing layer may be 0.025° C./W or greater and 5° C./W or less, the thickness of the releasing layer 8 need be 250 μm or less. Also, considering the durability of the releasing layer 8 for maintaining the releasing property, the thickness of the releasing layer 8 need be 10 μm or greater and therefore, the thickness of the releasing layer 8 is determined to 10 μm or greater and 250 μm or less. The heat conductivity of the releasing layer is much smaller than the heat conductivity of the mandrel and therefore, the heat resistance value of the roller 1 depends mostly on the thickness of the releasing layer.

The pressure roller 2, as shown in FIG. 2, is comprised of a mandrel 2a, an elastic layer 2b of silicone rubber provided on the mandrel 2a, and a releasing layer 2c of fluorine resin provided thereon. This pressure roller 2 forms a nip between itself and the fixing roller 1 rotated in operative association with a driving mechanism, not shown, and is driven to rotate. The elastic layer 2b of silicone rubber of the pressure roller 2 enables the roller to follow the thickness fluctuation (several μm to several tens of μm) of the toners in a color image ranging from monochrome to four colors superimposed one upon another.

So, by the use of the fixing apparatus A in the present embodiment and a fixing apparatus B which is a comparative experimental example in which the heat resistance of the inner surface to the surface of the fixing roller 1 is made high, the natures thereof will be described in Experimental Example 1 below.

### Experimental Example 1

Fixing Apparatus A: The fixing roller 1 used in this experimental example comprises an iron mandrel 1′ having a diameter of 40 mm and a thickness of 0.7 mm, and a releasing layer 8 which is fluorine resin PFA having a thickness of 20 μm and formed on the surface of the mandrel 1′. The pressure contact force (pressure force) of the pressure roller 2 against the fixing roller/was 100 to 300 N, and the width of the nip therebetween was 6.8 mm and the peripheral speed of the roller was 30 to 130 mm/sec. The fixing temperature was within the range of 150° C. to 190° C., and within this range, the ripple (fluctuation) was ±4° C.

In the above-described construction of the fixing roller 1 of the fixing apparatus A, the heat resistance values of iron and fluorine resin are found from the degrees of heat conduction and thicknesses thereof by the above-described method, and when those values are totaled, the heat resistance value per unit area (1 cm²) in the direction of heat transfer i.e., the thickness direction of the fixing roller 1 is calculated as follows.

TABLE 1

| | Heat | | Heat resistance |
|---|---|---|---|
| | conductivity | Thickness | value |
| | (W/m · ° C.) | (mm) | (° C./W) |
| iron (mandrel) | 67 | 0.7 | 0.105 |
| 1′ | | | |
| fluorine resin | 0.25 | 0.02 | 0.796 |
| releasing layer | | | |
| 8 | | | |

Heat resistance value in the thickness direction of fixing roller = 0.105 + 0.796 = 0.911 (° C./W)

The definition of heat conductivity (W/(m•° C.) is the quantity of heat flowing within a time of 1 second when there is a temperature difference of 1° C. between flat plates having a thickness of 1 m per 1 m^{2.} Accordingly, by dividing the thickness of the substance by the heat conductivity, the heat resistance value per 1 m² can be calculated. For example, the heat resistance of iron having an area of 1 m² and a thickness of 0.7 mm and heat conductivity of 67 ((W/m•° C.)) is (0.7×0.001) / 67=0.0000105(° C./W) and accordingly, the heat resistance per area of 1 cm² is 0.0000105×10000=0.105 (° C./W)

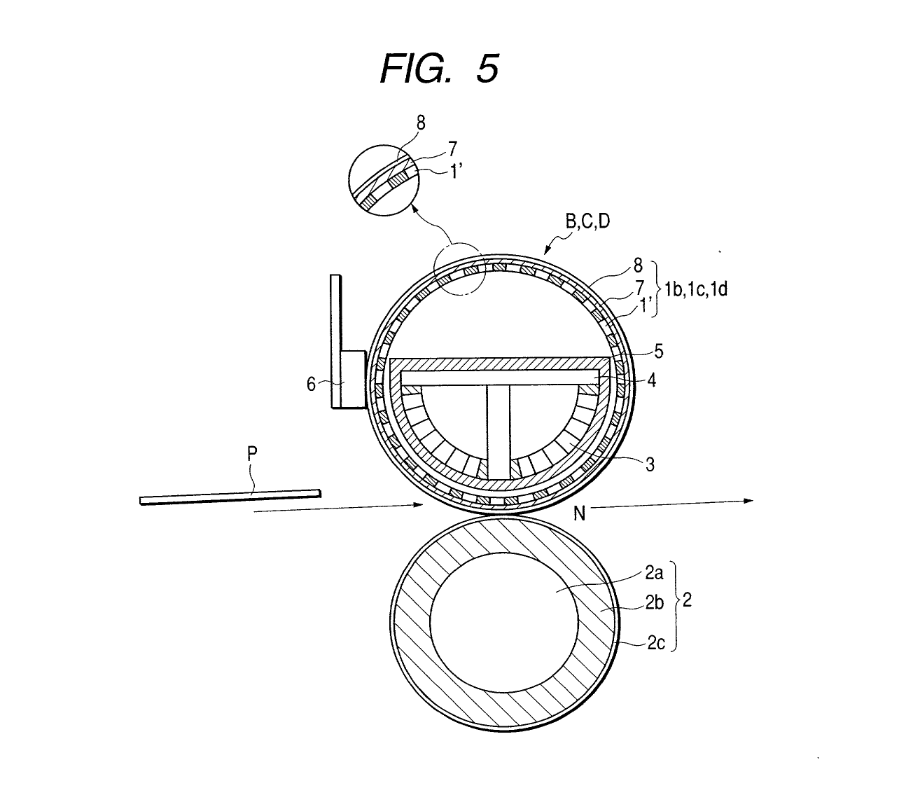

Fixing apparatus B: In order to compare the effect of the present invention, as shown in FIG. 5, there was made a fixing apparatus B in which the fixing roller 1 of the fixing apparatus A was interchanged with a fixing roller 1b comprising a fixing roller mandrel 1′, an Si rubber elastic layer 7 having a thickness of 1 mm and provided on the mandrel 1′, and a fluorine resin releasing layer 8 formed thereon to a thickness of 20 μm. The pressure roller 2 is the same in construction as that of the fixing apparatus A. In the construction of the fixing apparatus B as described above, the heat resistance value pa unit area (1 cm²) in the direction of heat transfer, i.e., the thickness direction of the fixing roller 1b is calculated as follows from the degrees of heat conduction and thicknesses of the fixing roller mandrel 1′, the Si rubber elastic layer 7 and the fluorine resin layer 8 by the above-described method.

TABLE 2

| | Heat | | Heat resistance |
|---|---|---|---|
| | conductivity | Thickness | value |
| | (W/m · ° C.) | (mm) | (° C./W) |
| iron (mandrel) | 67 | 0.7 | 0.105 |
| 1′ | | | |
| Si roller | 0.13 | 1 | 76.9 |
| (elastic layer) | | | |
| 7 | | | |
| fluorine resin 8 | 0.25 | 0.02 | 0.796 |

Heat resistance value in the thickness direction of fixing roller 1b = 0.105 + 76.9 + 0.796 = 77.8 (° C./W)

In the fixing apparatus A, no elastic layer was provided, but the fluorine resin layer was directly provided on the mandrel and the thickness of the fluorine resin releasing layer 8 was 20 μm, and as the result, the heat resistance per unit area (1 cm²) in the direction of heat transfer to the paper ad the toners, i.e., the thickness direction of the fixing roller, is 0.911 (° C./W) within the range of the heat resistance value of 0.025° C./W or greater and 5° C./W or less shown above. Because the heat resistance value is small, it becomes possible to melt the toners in a moment and cause the wax included therein to ooze out quickly, and good separating performance can be obtained.

Also, by using 800 W as fixing electric power, it is possible to suppress the lowering of temperature at the trailing edge of A3 recording paper which is the recording sheet P, and maintain good separating performance at the trailing edge as well, and the twining of the trailing edge of A3 recording paper did not occur and good separating performance was obtained even without a separating claw.

Also, when in the fixing apparatus A, at a controlled temperature of 180° C., the fixing of 40 sheets of A4 recording paper which is the recording sheet P per minute was effected for an hour on end, the temperature of the inducing coil 3 was of the order of 210° C. and this was a level free of problem to the heat resistance of resin.

The fixing apparatus A uses a hard roller mandrel having no elastic layer as the fixing roller mandrel 1′ and therefore is free of problems such as the peeling of rubber and the deterioration of rubber, and it is possible to secure good separating performance a long period and yet curtail the manufacturing cost, running cost, etc. of the fixing roller 1. In fact, in the construction of the fixing apparatus A, no problem was noted in the separating performance and the fixing performance even after the endurance test for 200,000 sheets, and even when there were no blanks on the leading edges of the recording sheets, a good fixing property and good separating performance were maintained.

Conversely, in the fixing apparatus B, the Si rubber layer 7 which is an elastic layer is provided and therefore, the heat resistance per unit area (1 cm²) in the thickness direction of the mandrel 1′ transferring heat to the recording sheet P and the toners becomes as great as 77.8(° C./W). Therefore, the toners are not melted in a moment and it becomes difficult to cause the wax included in the toners to ooze out quickly. Therefore, the releasing effect by the wax was not displayed, and the recording sheet P twined around the fixing roller 1b.

What is worse, when due to the heat resistance value being great, the fixing of 40 sheets of A4 recording paper which is the recording sheet P per minute was effected on end at a controlled temperature of 180° C., the temperature of the induction coil 3 rose to 260° C. or higher in about 10 minutes, and became a temperature exceeding the insulativeness of the induction coil 3 and the heat-resisting property of the holder 5.

From this experimental example, it is apparent that the smaller is the heat resistance value, the more easily the wax in the toners oozes out and the better is the separating property of the recording sheet and the more can be prevented the deterioration of the internal member of the fixing roller due to the temperature rise thereof. It is also apparent that conversely when the heat resistance value is great, the releasing effect by the wax in the toners lessens and the turning of the recording sheet is liable to occur and the rise of the internal temperature of the fixing roller arises and the deterioration of the internal member is liable to occur.

It has also become apparent that as in the fixing apparatus A, an elastic layer of silicon rubber or the like is not provided on the fixing roller mandrel 1′, but the uppermost releasing layer having a thickness of 10 μm or greater and 250 μm or less is directly provided on the fixing roller mandrel 1′, whereby it is possible to reduce the heat resistance value effectively.

Embodiment 2

In the fixing apparatus A of Embodiment 1, an elastic layer formed of silicon rubber is not Ha provided on the fixing roller 1 in order to make the heat resistance value small. However, in order to enable a nip to be secured between the fixing roller and the pressure roller 2, use can also be made of a fixing roller 1c having an elastic layer 7 of silicon rubber such as LTV, HTV or RTV, or fluorine rubber or fluorine rubber latex or the like provided under a releasing layer 8 of FEP, PFA, PTFE or the like or fluorine resin composed of a mixture thereof, as shown in FIG. 5. In this case, if the elasticity of the elastic layer 7 is small, the fixing of only the concave portions of a toner image or the deterioration of the image by the collapse of the toner will be brought about an therefore, elasticity of a suitable magnitude is required.

However, if the heat resistance value of the fixing roller becomes great by the elastic layer 7 which is a non-metallic heat conduction proof material layer being provided on the fixing roller, there will occur, as in the fixing apparatus B which is the comparative experimental example of Embodiment 1, such inconveniences as the reduction in the separating property by the fact that the releasing wax included in the toners does not ooze out, and the deterioration of the member in the fixing roller by the rise of the internal temperature of the fixing roller. Also, as regards the elastic layer 7 of the fixing roller, it is difficult to obtain stable separating performance and fixing performance because of the deterioration of the rubber, and the enduring life thereof is 100,000 sheets or less.

Accordingly, in the case of a fixing apparatus C of the same construction as the fixing apparatus B of FIG. 5 and using a fixing roller 1c provided with the elastic layer 7 as the fixing roller 1, it is necessary that the heat resistance value of the fixing roller 1c be within the range of 0.025° C./W or greater and 5° C./W or less which is the range of the heat resistance value described in Embodiment 1. It is not realistic to make the thickness of the mandrel 1′ small in order to make the heat resistance value small, because it poses a problem to the durability of the mandrel 1′. Also, the releasing layer 8 is necessary for the releasing property. Consequently, it is necessary to make the thickness of the elastic layer 7 as small as possible or use a material of high heat conductivity to thereby suppress the heat resistance value of the inner surface to the surface of the fixing roller within the range of 0.025° C./W or greater and 5° C./W or less.

So, by the use of the fixing apparatus C of the present embodiment in which the thickness of the elastic layer 7 is made small and a fixing apparatus D which is a comparative experimental example, the heat resistance from the coil 3 which is the heat source of the fixing roller 1 to the surface of the fixing roller is changed and the natures thereof will be described in Experimental Example 2 below.

### Experimental Example 2

Fixing Apparatus C: In order to compare the effect of the present invention, there was made a fixing apparatus C in which the fixing roller in the fixing apparatus B of FIG. 5 was interchanged with a fixing roller 1c in which the thickness of the Si rubber elastic layer 7 was made as small as 50 μm. IN this fixing apparatus C, the heat resistance in the thickness direction of the fixing roller 1c was calculated by the above-described method. As the result, the heat resistance value was about 4.75° C./W.

TABLE 3

| | Heat | | Heat resistance |
|---|---|---|---|
| | conductivity | Thickness | value |
| | (W/m · ° C.) | (mm) | (° C/W) |
| iron (mandrel) 1′ | 67 | 0.7 | 0.105 |
| Si rubber (elastic | 0.13 | 0.05 | 3.85 |
| layer) 7 | | | |
| Fluorine resin 8 | 0.25 | 0.02 | 0.796 |

Heat resistance value in the thickness direction of the fixing roller 1c = 0.105 + 3.85 + 0.796 = 4.75 (° C./W)

Fixing Apparatus D: There was made a fixing apparatus D in which the fixing roller was interchanged with a fixing roller 1d in which the thickness of the Si rubber elastic layer 7 in the aforedescribed fixing apparatus B was made as small as 0.1 mm. In this fixing apparatus D, the heat resistance value in the thickness direction of the fixing roller 1d was calculated by the above-described method. As the result, the heat resistance value was about 8.59° C./W.

TABLE 4

| | Heat | | Heat resistance |
|---|---|---|---|
| | conductivity | Thickness | value |
| | (W/m · ° C.) | (mm) | (° C/W) |
| iron (mandrel) 1′ | 67 | 0.7 | 0.105 |
| Si rubber (elastic | 0.13 | 0.1 | 7.69 |
| layer) 7 | | | |
| fluorine resin 8 | 0.25 | 0.02 | 0.796 |

Heat resistance value in the thickness direction of the fixing roller 1d = 0.105 + 7.69 + 0.796 = 8.59° C./W

When by the use of the fixing apparatus C and the fixing apparatus D, the natures of these two were compared as in Experimental Example 1, in the case of the fixing apparatus C using the fixing roller 1c in which the thickness of the Si rubber elastic layer 7 was further made as small as 50 μm, the heat resistance value calculated was about 4.75° C./W per 1 cm² in the direction of heat transfer. Here was no problem about the separating performance, and even without a separating claw, it did not happen that the recording sheet twined around the fixing roller 1c. Also, when fixing was continuously effected at a controlled temperature of 180° C. for 40 sheets of A4 recording paper which is the recording sheet P per minute, the temperature of the induction coil 3 became 220° C. in an hour, and no problem arose about the insulativeness of the induction coil 3 and the heat-resisting property of the resin or the holder 5.

However, in the fixing apparatus D using the fixing roller 1d in which the thickness of the Si rubber elastic layer 7 was 0.1 mm, the heat resistance value was about 8.59° C./W per 1 cm² in the direction of heat transfer, but the separating performance was further aggravated, and without a separating claw, the recording sheet twined around the fixing roller 1d. Also, when fixing was continuously effected at a controlled temperature of 180° C. for 40 sheets of A4 recording paper which is the recording sheet P per minute, the temperature of the induction coil 3 rose to the vicinity of 260° C. in 30 minutes or so, and reached a temperature exceeding the insulativeness of the induction coil 3 and the heat-resisting property of the holder 5.

Here, the fixing apparatus C having a heat resistance value of 4.75° C./W per 1 cm² in the direction of heat transfer could maintain the performance of the fixing apparatus A to the heat-resisting property of the member, where as the fixing apparatus D having a heat resistance value of 8.59° C. /W per 1 cm² in the direction of heat transfer exceeding 5° C./W which is the upper limit of the heat resistance value of the fixing roller 1 of the present invention causes the twining of the recording sheet P and the excessive internal temperature rise of the roller 1d. From this, it has become apparent that as described above, the heat resistance value must be 0.025° C./W or greater and 5° C./W or less per 1 cm² in the direction of heat transfer.

Embodiment 3

On the other hand, as another feature of the present invention, mention may be made of the fact that in the present embodiment, a sharp melt toner which is the non-magnetic toner of a monocomponent developer is used as the developer so that a good separating property may be obtained even when the amount of toner resting on an unfixed toner image formed on a recording material to be fixed in a color image forming apparatus is great. Further, this sharp melt toner is a polymerized toner manufactured by the polymerizing method, and includes therein a releasing agent such as wax or paraffin smaller in melt viscosity and molecular weight than the host resin of the toner. By using such a sharp melt toner by the polymerizing method, a high toner color mixing property was attained during fixing and also, a high releasing property was obtained by the oozing of the included wax out of the toner by heat, and the oillessness of fixing was realized.

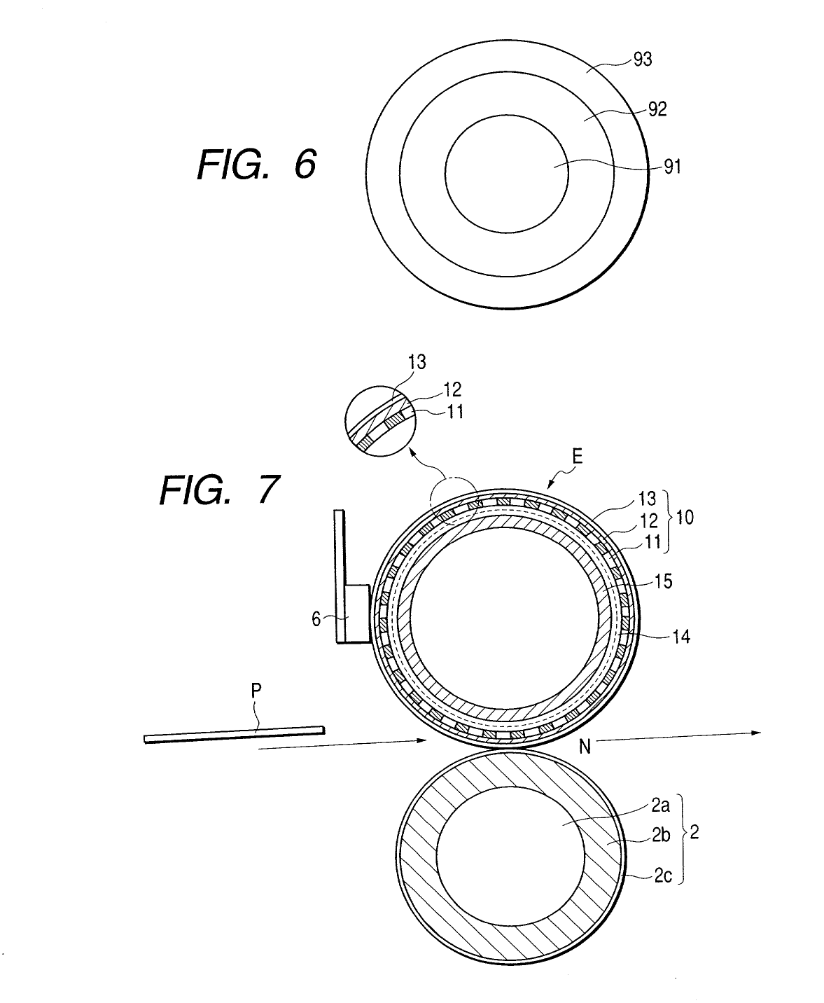

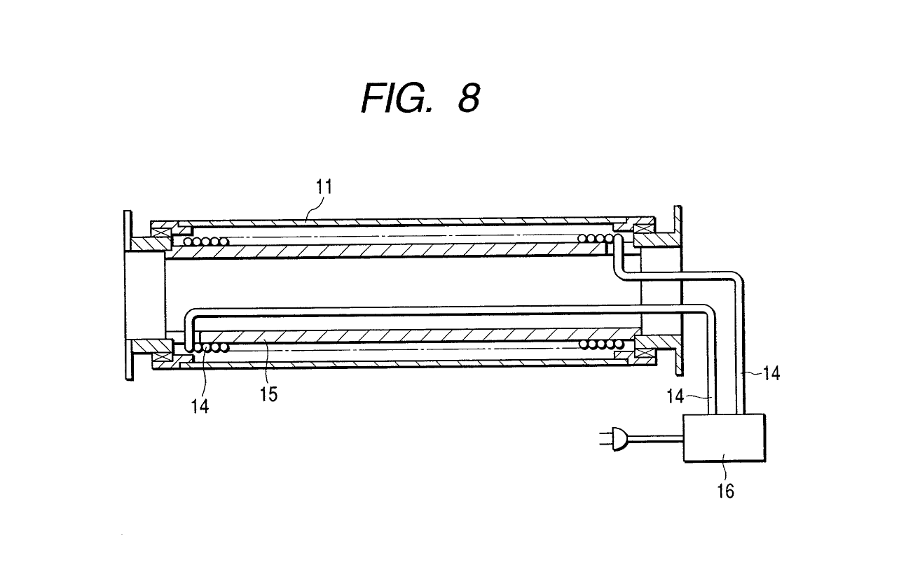

The construction of the polymerized toner is schematically shown in FIG. 6. The polymerized toner becomes spherical because of its manufacturing method. The polymerized toner is comprised of a core 91, a resin layer 92 thereon and a surface layer 93 thereon, and in the above-described experimental example, wax of ester origin is included in the core 91, and the resin layer 92 has styrene-butylacrylate resin as a main component, and the surface layer 93 has styrene-polyester resin as a main component.

The specific gravity of this polymerized toner is about 1.05. This polymerized toner is of three-layer structure from the interfacial characteristics of the core 91, the resin layer 92 and the surface layer 93, and the reason for the three-layer structure is to obtain the offset preventing effect at the fixing step by including wax in the core 91, and to achieve an improvement in the charging efficiency of the toner by providing the surface layer 93 which is a resin layer. When this polymerized toner is used, oil-treated silica is extraneously added thereto for the stabilization of frictional electrification charges.

Generally, as a method of manufacturing the spherical toner, mention may be made of:

(a) a so-called crushing method of uniformly dispersing a releasing agent including a low softening point substance (wax) included in the case, resin which is the resin layer and the surface layer, a coloring agent, a charging control agent, etc. by the use of a pressure kneader, an extruder or a media dispersing machine, and thereafter making them collide against a target mechanically or under a jet stream to thereby finely crush them into a desired toner particle shape, and thereafter further sharpening the particle size distribution by way of the classifying step to thereby make a toner:

(b) a method of atomizing a molten mixture into the air by the use of a disc or a multiparticle material nozzle described in Japanese Patent Publication No. 56-13954, etc. to thereby obtain a spherical toner;

(c) a polymerizing method of directly producing a toner by suspension polymerization described in Japanese Patent Publication No. 36-10231, Japanese Patent Application Laid-Open No. 59-53856 and Japanese Patent Application Laid-Open No. 59-61842; or

(d) an emulsion polymerizing method typified by a soap-free polymerizing method of directly producing a toner by the use of a water organic solvent to which a monomer is soluble and an obtained polymer is insoluble.

In the present embodiment, a sharp melt toner was manufactured by the use of the emulsion polymerizing method mentioned under item (c) above under normal pressure or under pressure in which fine particles sharp in particle size distribution and having a particle diameter of 4 to 8 μm could be obtained relatively easily. Styrene and n-butylacrylate were used as the monomer, a metal compound salicylate was used as the charging control agent, saturated polyester was used as the polarity At resin, and a coloring agent was added thereto to thereby obtain a coloring suspension particle having a weight average particle diameter of 7 μm, i.e., a sharp melt toner.

The control of the particle size distribution of the toner and the control of the particle diameter of the toner can be carried out by a method of changing the kind and amount of addition of difficultly water-soluble salt or a dispersing agent having protective colloid action, or by controlling the mechanical condition of an apparatus such as the peripheral speed of a roller, the frequency of pass, the agitating condition including the shape of agitating vanes and the shape of a container, or the density of the solid in a water soluble, and a predetermined toner in the present embodiment can be obtained.

As binding resin for use in the toner, utilization can be made of styrene-(metha)acryl copolymer, polyester resin, epoxy resin or styrene-butadiene copolymer being generally used.

The monomers of these resins are preferably used in the polymerizing method of directly producing the toner. Specifically, use is preferably made of a styrene monomer such as o-, m- or p-methyl styrene or m- or p-ethyl styrene; a (metha)acrylic ester monomer such as (metha)acrylic methyl, (metha)acrylic ethyl, (metha)acrylic propyl, (metha)acrylic butyl, (metha)acrylic octyl, (metha)acrylic dodecyl, (metha)acrylic stearyl, (metha)acrylic behenyl, (metha)acrylic 2-ethyl hexyl, (metha)acrylic dimethyl aminoethyl or (metha)acrylic diethyl aminoethyl; or an ester monomer such as butadiene, isoprene, cyclohexene, (metha)acryl nitrile or acrylic amide.

These monomers are used singly, or generally, as the theoretical glass transition temperature (Tg) described in Polymer Handbook, Second Edition III, pp. 139-192 (John Wiley & Sons) indicates 40 to 75° C., the monomer are suitably mixed and used. When the theoretical glass transition temperature of a mixture of monomers is below 40° C., a problem arises about the preservation stability or endurance stability of the toner, and when it exceeds 75° C., the rise of the fixing temperature is brought about and particularly, in a full color toner, the mixing of respective color toners becomes insufficient and is poor in the reproducibility of colors and further, the transparency of a transparent image is remarkably reduced and a color image of a high quality cannot be obtained.

The molecular weight of the binding resin is measured by GPC (gel permeation chromatography). In measuring, the toner is extracted for 20 hours by toluene which is a solvent by the use of a Soxhlet extractor, and then toluene is evaporated by a rotary evaporator, and an organic solvent to which wax of ester origin is soluble but the binding resin is insoluble, for example, chloroform or the like is added to the residual thereof to wash the latter sufficiently, whereafter the residual is dissolved in THF (tetrahydrofuran) and then is filtrated through a solvent-resistant membrane filter having a pore diameter of 0.3 μm to thereby prepare resin (solution) which is a sample. Columns A-801, 802, 803, 804, 805, 806 and 807 produced by Showa Denko Co. Ltd. Were connected to GPC (model 150c) produced by Waters, Inc-, and the obtained sample solution was injected thereinto, and the molecular weight of the binding resin was measured by the analytical curve of standard polystyrene resin to thereby find a molecular weight distribution. It is preferable for the binding resin of the toner in the present embodiment that the number average molecular weight Mn of the binding resin be 5,000 to 1,000,000 and the ratio Mw/Mn between the weight average molecular weight Mw and the number average molecular weight Mn be 2 to 100. The molecular weight of wax may preferably be smaller than the molecular weight of the binding resin, and be of the order of several thousands to several tens of thousands in terms of the number average molecular weight.

Coloring agents used in the toners are as follows. As a black coloring agent, use is made of a magnetic material such as carbon black or magnetite, or yellow, magenta and cyan coloring agents mixed together and prepared as black.

As the yellow coloring agent, use is made of a component typified by a condensed azo compound, an ioindolinone compound, an anthraquinone compound, an azo metal complex, a methine compound, or an allylamide compound. Specifically, C.I. pigment yellow 12, 13, 14, 15, 17, 62, 74, 83, 93, 94, 95, 97, 109, 110, 111, 120, 127, 128, 129, 147, 168, 174, 176, 180, 181, 191 or the like is suitably used.

As the magenta coloring agent, use is made of a condensed azo compound, a diketopyrolopyrol compound, an anthraquinone compound, a quinacridone compound, a basis dye lake compound, a naphthol compound, a benzimidazolon compound, a thioindigo compound or a perylene compound. Specifically, C.I. pigment red 2, 3, 5, 6, 7, 23, 48; 2, 48; 3, 48; 4, 57; 1, 81; 1, 144, 146, 166, 169, 177, 184, 185, 202, 220, 221 or 254 is particularly preferable.

As the cyan coloring agent, utilization can be made of a copper phthalocyanine compound and a derivative thereof, an anthraquinone compound, a basic dye lake compound or the like. C.I. pigment blue 1, 7, 15; 1, 15; 2, 15; 3, 15; 4, 60, 62, 66 or the like can be particularly suitably utilized.

These coloring agents are used singly or mixedly, and further can be used in the state of solid solution. The coloring agents are selected with the hue angle, chroma, brightness, weather resistance, Trapen permeability and dispersibility into toner taken into account. The amount of addition of the coloring agent is 1 to 20 parts by weight to resin of 100 parts by weight. When a magnetic material is used as the black coloring agent, unlike the other coloring agents, 40 to 150 parts by weight to resin of 100 parts by weight is added for use.

While in the present embodiment, use is made of toners including therein wax by the polymerizing method, it is not necessary to restrict them to the toner by this manufacturing method, but such toners that the releasing agent oozes out quickly by giving heat quickly thereto can be manufactured.

If the toners as described above are used and design is made such that the heat resistance value in the thickness direction of the fixing roller is 0.025° C./W or greater and 5° C./W or less, the wax included in the toners will ooze out in a moment and therefore, there can be provided a fixing apparatus and an image forming apparatus in which the amount of resting toner is great and even if the fixing roller is made small, the separability of the recording sheet is good and problems such as the twining of the recording sheet and the bad fixing on the lower end of the recording sheet can be prevented, and the excessive internal temperature rise of the fixing roller can be avoided and the deterioration of the internal member of the fixing roller can be prevented, and which can be quickly started with energy saving and can form good images.

The present invention is not restricted to the above-described embodiments, but covers modifications identical in technical idea with the invention.

What is claimed is:

1. An image heating apparatus for heating an image formed on a recording material, comprising:
a heat generating member; and
an excitation coil for generating a magnetic field to induce an eddy current in said heat generating member;
wherein a heat resistance value of said heat generating member per 1 cm² is 0.025(° C./W) or greater and 5(° C./W) or less.

2. An image heating apparatus according to claim 1, wherein said heat generating member includes an electrically conductive layer in which an eddy current is generated, and a surface layer, and a thickness of said surface layer is 10 μm or greater and 250 μm or less.

3. An image heating apparatus according to claim 2, wherein said heat generating member further includes an elastic layer between said electrically conductive layer and said surface layer.

4. An image heating apparatus according to claim 2, wherein said surface layer is a fluorine resin layer.

5. An image heating apparatus according to claim 1, wherein said heat generating member contacts with a toner image on the recording material to thereby heat and fix the toner image, and the toner. includes wax.
